(19) United States
(12) Patent Application Publication
(10) Pub. No.: US 2026/0009375 A1
(43) Pub. Date: Jan. 8, 2026

(54) FLUID MATERIAL POWERED GENERATOR DEVICE

(71) Applicant: Nick Garber, Washington, PA (US)

(72) Inventor: Nick Garber, Washington, PA (US)

(21) Appl. No.: 18/761,494

(22) Filed: Jul. 2, 2024

(51) Int. Cl. F03D 9/25; F03D 9/11; F03D 9/32

(52) U.S. Cl. CPC F03D 9/25; F03D 9/11; F03D 9/32

(57) ABSTRACT

A fluid material powered generator device for converting rotational energy into electrical energy includes an impeller pipe that is attachable to a fluid source thereby enabling a fluid material from the fluid source to flow through the impeller pipe. A plurality of impeller units is each rotatably attached to the impeller pipe thereby enabling the fluid material from the fluid source to rotate each of the impeller units when the fluid material flows through the impeller pipe. A plurality of transducers is each attached to the impeller pipe. Each of the plurality of transducers is in mechanical communication with a respective one of the plurality of impeller units thereby enabling each of the plurality of transducers to convert rotational energy of the respective impeller unit into electrical energy.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fluid generator devices and more particularly pertains to a new fluid generator device for rotational energy into electrical energy. The device includes an impeller pipe that is fluidly attached to a fluid source and a plurality of impeller units each rotationally integrated into the fluid pipe. In this way the plurality of impeller units are rotated by a fluid material that flows through the impeller pipe. The device includes a plurality of transducers each attached to the fluid pipe and each of the transducers are in mechanical communication with a respective impeller unit. In this way the transducers convert rotational energy of the impeller units into electrical energy.

### (2) Description of Related Art Including Information Disclosed Under 37 CFR 1.97 and 1.98

The prior art relates to fluid generator devices including a variety of fluid generator devices that each at least includes turbines that are integrated into a fluid pipe which carries a flowing fluid for generating electricity from the flowing fluid. In no instance does the prior art disclose a fluid generator device that includes an impeller pipe that is fluidly attached to a fluid pipe and a plurality of impeller units integrated into the impeller pipe which are driven by a fluid flowing through the impeller pipe and a plurality of transducers attached to the impeller pipe for converting rotational energy of the impeller units into electrical energy.

### BRIEF SUMMARY OF THE INVENTION

An embodiment of the disclosure meets the needs presented above by generally comprising an impeller pipe that is attachable to a fluid source thereby enabling a fluid material from the fluid source to flow through the impeller pipe. A plurality of impeller units is each rotatably attached to the impeller pipe thereby enabling the fluid material from the fluid source to rotate each of the impeller units when the fluid material flows through the impeller pipe. A plurality of transducers is each attached to the impeller pipe. Each of the plurality of transducers is in mechanical communication with a respective one of the plurality of impeller units thereby enabling each of the plurality of transducers to convert rotational energy of the respective impeller unit into electrical energy.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a fluid material powered generator device according to an embodiment of the disclosure.

FIG. 2 is a cross sectional view taken along line 2-2 of FIG. 1 of an embodiment of the disclosure.

FIG. 3 is a cross sectional view taken along line 3-3 of FIG. 2 of an embodiment of the disclosure.

FIG. 4 is a perspective in-use view of an embodiment of the disclosure showing an impeller pipe being fluidly attached to a fluid source.

FIG. 5 is a perspective in-use view of an embodiment of the disclosure showing a pair of impeller pipes being integrated into a vehicle.

### DETAILED DESCRIPTION OF THE INVENTION

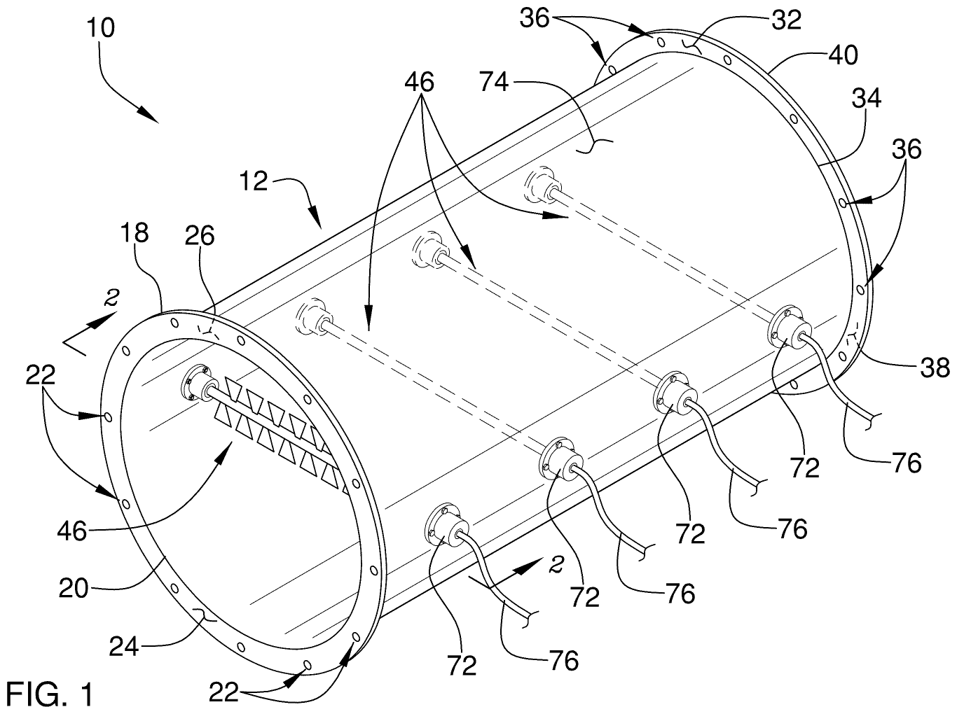

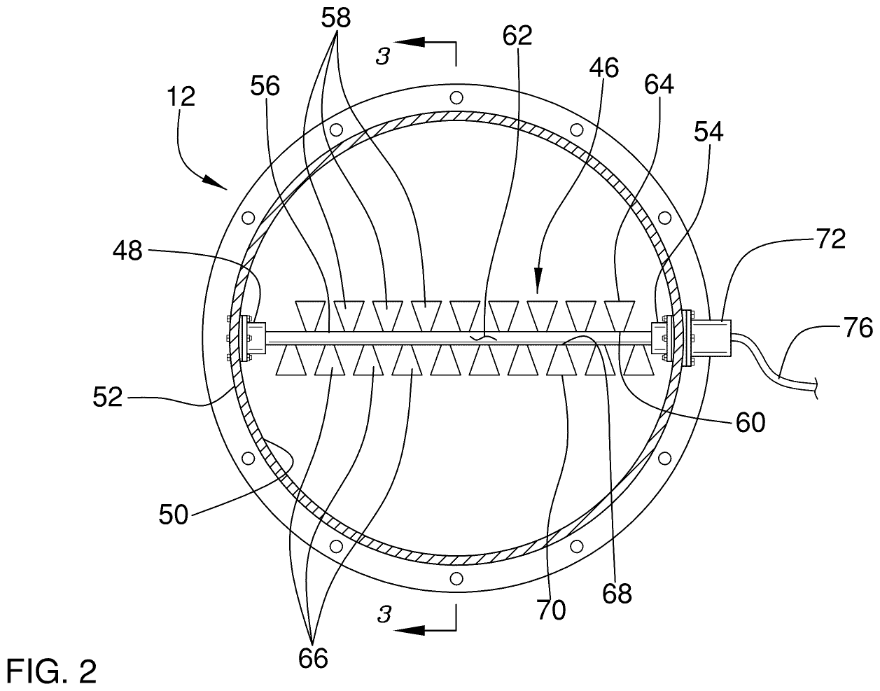

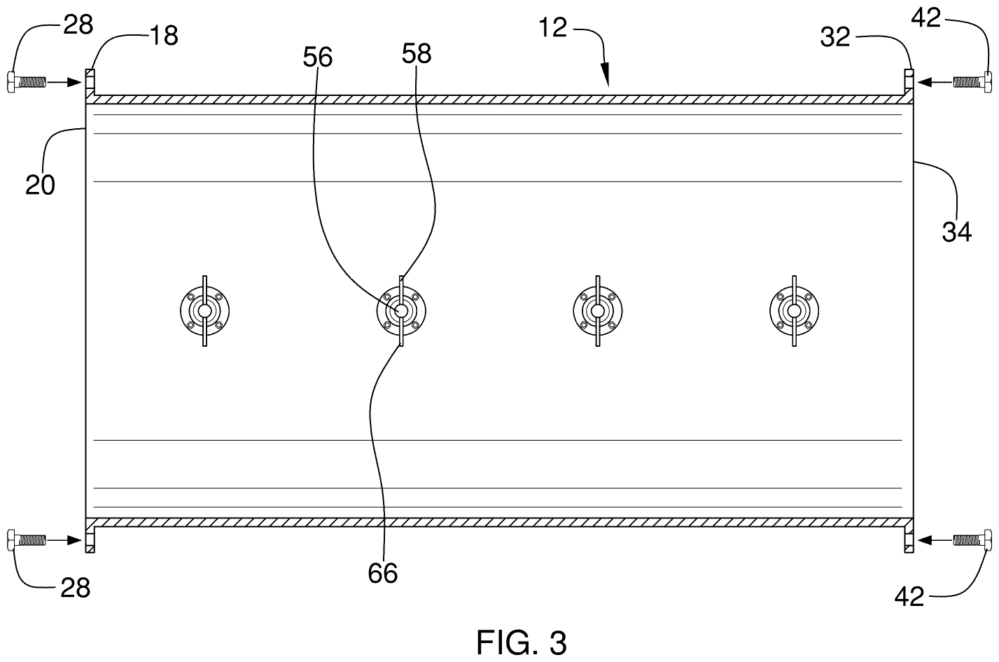

With reference now to the drawings, and in particular to FIGS. 1 through 5 thereof, a new fluid generator device embodying the principles and concepts of an embodiment of the disclosure and generally designated by the reference numeral 10 will be described.

As best illustrated in FIGS. 1 through 5, the fluid material powered generator device 10 generally comprises an impeller pipe 12 that is attachable to a fluid source 14 thereby enabling a fluid material 16 from the fluid source 14 to flow through the impeller pipe 12. The impeller pipe 12 has a first flange 18 which is located on a first end 20 of the impeller pipe 12. The first flange 18 has a plurality of first holes 22 each extending through a front surface 24 and a back surface 26 of the first flange 18 thereby enabling a fastener 28 to be extended through the each of the plurality of first holes 22 for mating the first flange 18 to a conduit 30 associated with the fluid source 14. Additionally, the first holes 22 are evenly spaced apart from each other and are distributed around a full circumference of the first flange 18. The impeller pipe 12 has a second flange 32 which is located on a second end 34 of the impeller pipe 12. The second flange 32 has a plurality of second holes 36 each extending through a front surface 38 and a back surface 40 of the second flange 32 thereby enabling a fastener 42 to be extended through the each of the plurality of second holes 36 for mating the second flange 32 to a conduit 44 associated with the fluid source 14. Additionally, the second holes 36 are evenly spaced apart from each other and are distributed around a full circumference of the second flange 32.

A plurality of impeller units 46 is each rotatably attached to the impeller pipe 12 such that each of the plurality of impeller units 46 is positioned within the impeller pipe 12. In this way the fluid material 16 from the fluid source 14 can rotate each of the impeller units 46 when the fluid material 16 flows through the impeller pipe 12. The plurality of impeller units 46 is evenly spaced apart from each other and is distributed along a full length of the impeller pipe 12. Each of the plurality of impeller units 46 comprises a first bearing 48 which is attached to an interior surface 50 of an outer wall 52 of the impeller pipe 12 and a second bearing 54 which is attached to the interior surface 50 of the outer wall 52 of the impeller pipe 12. The second bearing 54 is positioned on an opposing side of the interior surface 50 with respect to the first bearing 48 such that the second bearing 54 is aligned with the first bearing 48.

Each of the impeller units 46 includes a shaft 56 which extends through each of the first bearing 48 and the second bearing 54 thereby enabling the shaft 56 to rotate about an axis extending between the first bearing 48 and the second bearing 54. Each of the impeller units 46 includes a plurality of first blades 58 which is each has a coupled end 60 that is coupled to an outer surface 62 of the shaft 56 thereby enabling the fluid material 16 to frictionally engage each of the first blades 58. In this way the shaft 56 is rotated when the fluid material 16 flows through the impeller pipe 12. Each of the plurality of first blades 58 has a distal end 64 with respect to the outer surface 62 of the shaft 56 and each of the first blades 58 widens between the coupled end 60 and the distal end 64. Furthermore, the plurality of first blades 58 is evenly spaced apart from each other and is distributed between the first bearing 48 and the second bearing 54.

Each of the impeller units 46 includes a plurality of second blades 66 which each has a coupled end 68 that is coupled to an outer surface 62 of the shaft 56 thereby enabling the fluid material 16 to frictionally engage each of the second blades 66. In this way the shaft 56 is rotated when the fluid material 16 flows through the impeller pipe 12. Each of the plurality of second blades 66 has a distal end 70 with respect to the outer surface 62 of the shaft 56 and each of the second blades 66 widens between the coupled end 68 of the second blades 66 and the distal end 70 of the second blades 66. Additionally, the plurality of second blades 66 is evenly spaced apart from each other and is distributed between the first bearing 48 and the second bearing 54. Furthermore, each of the plurality of second blades 66 is positioned on an opposing side of the outer surface 62 of the shaft 56 with respect to the plurality of first blades 58 and each of the plurality of second blades 66 is located between a respective pair of the first blades 58.

A plurality of transducers 72 is provided and each of the plurality of transducers 72 is attached to the impeller pipe 12. Each of the plurality of transducers 72 is in mechanical communication with a respective one of the plurality of impeller units 46 thereby enabling each of the plurality of transducers 72 to convert rotational energy of the respective impeller unit 46 into electrical energy. Each of the plurality of transducers 72 is attached to an exterior surface 74 of the outer wall 52 of the impeller pipe 12. Furthermore, the shaft 56 associated with the respective impeller unit 46 extends through the outer wall 52 of the impeller pipe 12 to enable the shaft 56 associated with the respective impeller unit 46 to be in mechanical communication with a respective one of the plurality of transducers 72. In this way plurality of transducers 72 converts the rotational energy of the shaft 56 associated with the respective impeller unit 46 into electrical energy when the plurality of first blades 58 and the plurality of second blades 66 associated with the respective impeller unit 46 rotates the shaft 56 associated with the respective impeller unit 46. A plurality of conductors 76 is provided and each of the plurality of conductors 76 is electrically coupled between a respective one of the plurality of transducers 72 and a power storage unit 78. Additionally, each of the plurality of conductors 76 is comprised of an electrically conductive material thereby enabling electrical energy produced by each of the plurality of transducers 72 to be stored in the power storage unit 78.

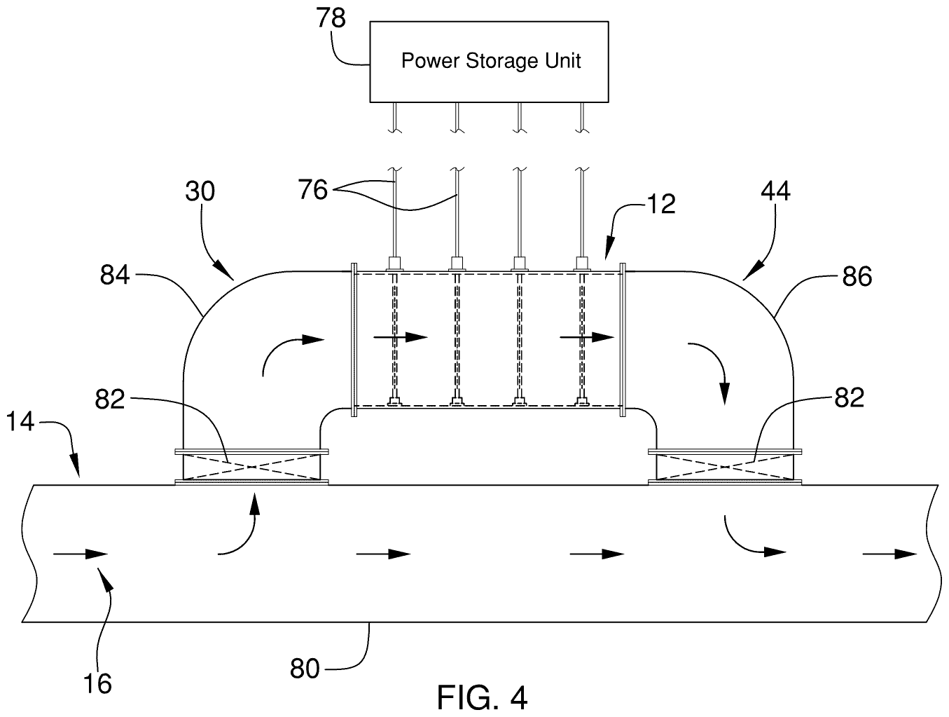

As is most clearly shown in FIG. 4, the fluid source 14 comprises a fluid pipe 80 for transporting the fluid material 16. Furthermore, the fluid material 16 may comprise a viscous liquid, such as water for example, which flows through the fluid pipe 80 for transporting the viscous liquid. Furthermore, the fluid material 16 may be a gaseous material, such as natural gas for example, which flows through the fluid pipe 80 for transporting the gaseous material. Additionally, the fluid pipe 80 may be a municipal water pipe or a natural gas pipe.

Additionally, as is shown in FIG. 4, a pair of fluid control valves 82 may each be integrated into a respective one of an intake pipe 84 that is fluidly coupled between the fluid pipe 80 and the first flange 18 and an exhaust pipe 86 that is fluidly coupled between the fluid pipe 80 and the second flange 32. Each of the fluid control valves 82 may be electrically controlled to open to enable the fluid material 16 or the gaseous material to flow through the impeller units 46. Conversely, each of the fluid control valves 82 may be electrically controlled to close to enable the fluid material 16 or the gaseous material to bypass the impeller pipe 12. Additionally, the power storage unit 78 is remotely located with respect to the fluid source 14 and impeller pipe 12 and the power storage unit 78 may comprise an existing electrical grid that services a municipality, city or rural area, for example.

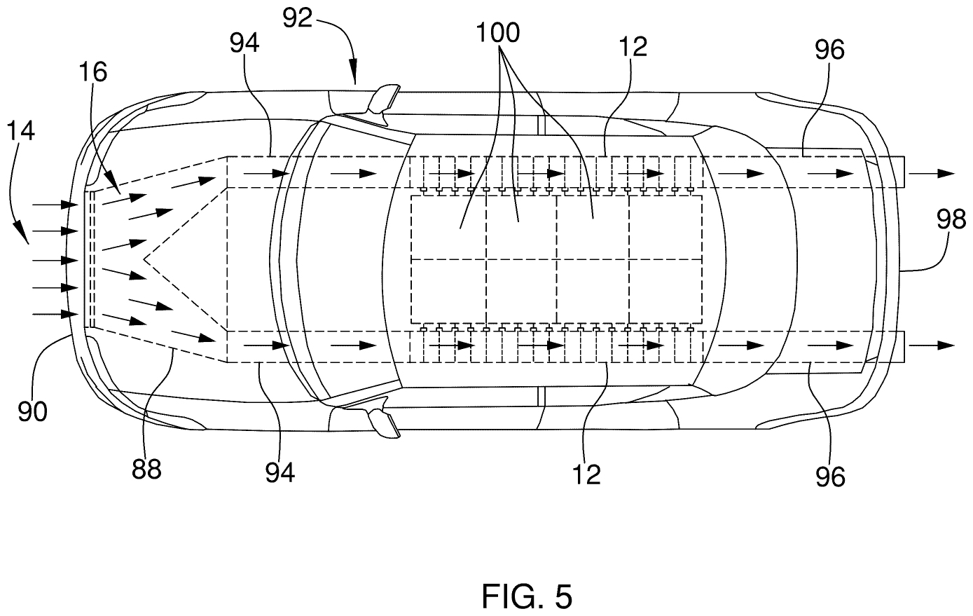

As is shown in FIG. 5, the fluid source 14 includes an air intake 88 which is integrated into a front end 90 of a vehicle 92 and the fluid material 16 comprises air which flows into the air intake 88 when the vehicle 92 is travelling forwardly. The vehicle 92 may be an electric passenger vehicle or an electric cargo vehicle that is commonly driven on public roadways. The fluid source 14 includes a pair of air intake ducts 94 which are each fluidly coupled to the air intake 88 thereby enabling the air to flow through each of the pair of air intake ducts 94 when the vehicle 92 is travelling forwardly.

As is additionally shown in FIG. 5, a pair of the impeller pipes 12 is provided and the first flange 18 associated with each of the pair of impeller pipes 12 is fluidly coupled to a respective one of the pair of air intake ducts 94 thereby enabling the air to flow through each of the pair of impeller pipes 12. In this way the air flowing through the pair of impeller pipes 12 can drive the impeller units 46 in each of the pair of impeller pipes 12. The fluid source 14 includes a pair of air exhaust ducts 96 which each extends through a rear end 98 of the vehicle 92 and the second flange 32 associated with each of the pair of impeller pipes 12 is fluidly coupled to a respective one of the pair of air exhaust ducts 96. In this way the air is enabled to flow through each of the pair of air exhaust ducts 96 and outwardly through the rear end 98 of the vehicle 92. Furthermore, the power storage unit 78 comprises a plurality of batteries 100 which are each stored within the vehicle 92.

In use, as is shown in FIG. 4, the impeller pipe 12 is installed on the fluid pipe 80 to enable the fluid material 16 which flows through the fluid pipe 80 to be directed to flow through the impeller pipe 12 thereby enabling the plurality of transducers 72 to convert the rotational energy of the impeller units 46 into electrical energy. In this way the electrical energy can be produced in a clean manner and subsequently employed in an electrical grid, for example, during times of natural disaster or to simply reduce the load of the electrical grid to supply the electrical energy required to service the municipality, city or rural area. As is shown in FIG. 5, the pair of impeller pipes 12 are installed in the vehicle 92 to enable the forced air which flows through the air intake 88 in the vehicle 92 to drive the impeller units 46 in each of the impeller pipes 12. In this way the batteries 100 in the vehicle 92 are charged while the vehicle 92 is travelling thereby reducing the need to charge the batteries 100 when the vehicle 92 is stationary. In each case the impeller units 46 supply clean electrical energy with limited impact on the surrounding environment for enhancing the available electrical energy for public use or for private use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fluid material powered generator device for converting the energy of a moving fluid material into electrical energy, said device comprising:
an impeller pipe being attachable to a fluid source thereby enabling a fluid material from said fluid source to flow through said impeller pipe;
a plurality of impeller units, each of said plurality of impeller units being rotatably attached to said impeller pipe such that each of said plurality of impeller units is positioned within said impeller pipe thereby enabling said fluid material from said fluid source to rotate each of said impeller units when said fluid material flows through said impeller pipe, said plurality of impeller units being evenly spaced apart from each other and being distributed along a full length of said impeller pipe; and
a plurality of transducers, each of said plurality of transducers being attached to said impeller pipe, each of said plurality of transducers being in mechanical communication with a respective one of said plurality of impeller units thereby enabling each of said plurality of transducers to convert rotational energy of said respective impeller unit into electrical energy.

2. The device according to claim 1, wherein:
said impeller pipe has a first flange being located on a first end of said impeller pipe;
said first flange has a plurality of first holes each extending through a front surface and a back surface of said first flange thereby enabling a fastener to be extended through said each of said plurality of first holes for mating said first flange to a conduit associated with said fluid source;
said first holes are evenly spaced apart from each other and are distributed around a full circumference of said first flange;
said impeller pipe has a second flange being located on a second end of said impeller pipe;
said second flange has a plurality of second holes each extending through a front surface and a back surface of said second flange thereby enabling a fastener to be extended through said each of said plurality of second holes for mating said second flange to a conduit associated with said fluid source;
said second holes are evenly spaced apart from each other and are distributed around a full circumference of said second flange; and
each of said plurality of transducers is attached to an exterior surface of said outer wall of said impeller pipe.

3. The device according to claim 1, wherein each of said plurality of impeller units comprises:
a first bearing being attached to an interior surface of an outer wall of said impeller pipe;
a second bearing being attached to said interior surface of said outer wall of said impeller pipe, said second bearing being positioned on an opposing side of said interior surface with respect to said first bearing such that said second bearing is aligned with said first bearing;
a shaft extending through each of said first bearing and said second bearing thereby enabling said shaft to rotate about an axis extending between said first bearing and said second bearing;
a plurality of first blades, each of said plurality of first blades having a coupled end being coupled to an outer surface of said shaft thereby enabling said fluid material to frictionally engage each of said first blades such that said shaft is rotated when said fluid material flows through said impeller pipe, each of said plurality of first blades having a distal end with respect to said outer surface of said shaft, each of said first blades widening between said coupled end and said distal end, said plurality of first blades being evenly spaced apart from each other and being distributed between said first bearing and said second bearing; and
a plurality of second blades, each of said plurality of second blades having a coupled end being coupled to an outer surface of said shaft thereby enabling said fluid material to frictionally engage each of said second blades such that said shaft is rotated when said fluid material flows through said impeller pipe, each of said plurality of second blades having a distal end with respect to said outer surface of said shaft, each of said second blades widening between said coupled end of said second blades and said distal end of said second blades, said plurality of second blades being evenly spaced apart from each other and being distributed between said first bearing and said second bearing, each of said plurality of second blades being positioned on an opposing side of said outer surface of said shaft with respect to said plurality of first blades, each of said plurality of second blades being located between a respective pair of said first blades.

4. The device according to claim 3, wherein said shaft associated with a respective one of said plurality of impeller units is in mechanical communication with a respective one of said plurality of transducers for converting rotational energy of said shaft associated with said respective impeller unit into electrical energy when said plurality of first blades and said plurality of second blades associated with said respective impeller unit rotates said shaft associated with said respective impeller unit.

5. The device according to claim 1, wherein:
said device includes a plurality of conductors;
each of said plurality of conductors is electrically coupled between a respective one of said plurality of transducers and a power storage unit; and
each of said plurality of conductors is comprised of an electrically conductive material thereby enabling electrical energy produced by each of said plurality of transducers to be stored in said power storage unit.

6. A fluid material powered generator device for converting the energy of a moving fluid material into electrical energy, said device comprising:
a impeller pipe being attachable to a fluid source thereby enabling a fluid material from said fluid source to flow through said impeller pipe, said impeller pipe having a first flange being located on a first end of said impeller pipe, said first flange having a plurality of first holes each extending through a front surface and a back surface of said first flange thereby enabling a fastener to be extended through said each of said plurality of first holes for mating said first flange to a conduit associated with said fluid source, said first holes being evenly spaced apart from each other and being distributed around a full circumference of said first flange, said impeller pipe having a second flange being located on a second end of said impeller pipe, said second flange having a plurality of second holes each extending through a front surface and a back surface of said second flange thereby enabling a fastener to be extended through said each of said plurality of second holes for mating said second flange to a conduit associated with said fluid source, said second holes being evenly spaced apart from each other and being distributed around a full circumference of said second flange;
a plurality of impeller units, each of said plurality of impeller units being rotatably attached to said impeller pipe such that each of said plurality of impeller units is positioned within said impeller pipe thereby enabling said fluid material from said fluid source to rotate each of said impeller units when said fluid material flows through said impeller pipe, said plurality of impeller units being evenly spaced apart from each other and being distributed along a full length of said impeller pipe, each of said plurality of impeller units comprising:
a first bearing being attached to an interior surface of an outer wall of said impeller pipe;
a second bearing being attached to said interior surface of said outer wall of said impeller pipe, said second bearing being positioned on an opposing side of said interior surface with respect to said first bearing such that said second bearing is aligned with said first bearing;
a shaft extending through each of said first bearing and said second bearing thereby enabling said shaft to rotate about an axis extending between said first bearing and said second bearing;
a plurality of first blades, each of said plurality of first blades having a coupled end being coupled to an outer surface of said shaft thereby enabling said fluid material to frictionally engage each of said first blades such that said shaft is rotated when said fluid material flows through said impeller pipe, each of said plurality of first blades having a distal end with respect to said outer surface of said shaft, each of said first blades widening between said coupled end and said distal end, said plurality of first blades being evenly spaced apart from each other and being distributed between said first bearing and said second bearing; and
a plurality of second blades, each of said plurality of second blades having a coupled end being coupled to an outer surface of said shaft thereby enabling said fluid material to frictionally engage each of said second blades such that said shaft is rotated when said fluid material flows through said impeller pipe, each of said plurality of second blades having a distal end with respect to said outer surface of said shaft, each of said second blades widening between said coupled end of said second blades and said distal end of said second blades, said plurality of second blades being evenly spaced apart from each other and being distributed between said first bearing and said second bearing, each of said plurality of second blades being positioned on an opposing side of said outer surface of said shaft with respect to said plurality of first blades, each of said plurality of second blades being located between a respective pair of said first blades;
a plurality of transducers, each of said plurality of transducers being attached to said impeller pipe, each of said plurality of transducers being in mechanical communication with a respective one of said plurality of impeller units thereby enabling each of said plurality of transducers to convert rotational energy of said respective impeller unit into electrical energy, each of said plurality of transducers being attached to an exterior surface of said outer wall of said impeller pipe, said shaft associated with said respective impeller unit being in mechanical communication with a respective one of said plurality of transducers for converting rotational energy of said shaft associated with said respective impeller unit into electrical energy when said plurality of first blades and said plurality of second blades associated with said respective impeller unit rotates said shaft associated with said respective impeller unit; and
a plurality of conductors, each of said plurality of conductors being electrically coupled between a respective one of said plurality of transducers and a power storage unit, each of said plurality of conductors being comprised of an electrically conductive material thereby enabling electrical energy produced by each of said plurality of transducers to be stored in said power storage unit.

7. The device according to claim 6, wherein:
said fluid source comprises a fluid pipe for transporting said fluid material;
said fluid material comprises a viscous liquid which flows through said fluid pipe for transporting said viscous liquid; and
said power storage unit is remotely located with respect to said fluid source and impeller pipe.

8. The device according to claim 6, wherein:
said fluid source includes an air intake being integrated into a front end of a vehicle;
said fluid material comprises air which flows into said air intake when said vehicle is travelling forwardly;
said fluid source includes a pair of air intake ducts which are each fluidly coupled to said air intake thereby enabling said air to flow through each of said pair of intake ducts when said vehicle is travelling forwardly;
a pair of said impeller pipes is provided;
said first flange associated with each of said pair of impeller pipes is fluidly coupled to a respective one of said pair of air intake ducts thereby enabling said air to flow through each of said pair of impeller pipes;
said fluid source includes a pair of air exhaust ducts which each extends through a rear end of said vehicle; and
said second flange associated with each of said pair of impeller pipes is fluidly coupled to a respective one of said pair of air exhaust ducts thereby enabling said air to flow through each of said pair of air exhaust ducts and outwardly through said rear end of said vehicle.

9. The device according to claim 8, wherein said power storage unit comprises a plurality of batteries which are each stored within said vehicle.
